(19) United States
(12) Patent Application Publication
(10) Pub. No.: US 2016/0302448 A1
(43) Pub. Date: Oct. 20, 2016

(54) MULTI-LAYER DOG CHEW WITH DAIRY-BASED INTERNAL LAYER

(71) Applicants: Brett Weinberg, San Clemnete, CA (US); Lucas Saxe, Laguna Beach, CA (US); Michael Farmer, Southlake, TX (US)

(72) Inventors: Brett Weinberg, San Clemnete, CA (US); Lucas Saxe, Laguna Beach, CA (US); Michael Farmer, Southlake, TX (US)

(21) Appl. No.: 15/133,661

(22) Filed: Apr. 20, 2016

Related U.S. Application Data
(60) Provisional application No. 62/150,151, filed on Apr. 20, 2015.

(51) Int. Cl. A23K 40/20; A23K 10/20; A23K 40/25; A23K 10/26; A23K 50/42; A23K 40/10

(52) U.S. Cl. CPC A23K 40/20; A23K 50/42; A23K 40/10; A23K 40/25; A23K 10/26; A23K 10/20

(57) ABSTRACT

A dog chew formed from an external outer casing made of predominantly animal hide and in an internal dairy-based material, the majority of which is concealed within the animal hide outer casing. The dairy-based material is a mixture of one or more dairy ingredients that may or may not be combined with one or more binding agents and preservatives, and said mixture of one or more dairy ingredients comprises the largest portion, by weight, of the dog chew, and said binding agent is added in a sufficient quantity to allow the dairy-based material to be pliable and stable.

### FIELD OF THE INVENTION

The present invention relates to dog chews, in particular a versatile multi-layer chew comprising a dairy-based internal layer and an animal hide outer layer, providing nutritional and other positive benefits, while also providing a positive chewing activity for a pet which can help deter poor behavior such as chewing on furniture and promote oral health through the mechanical chewing activity.

### BACKGROUND OF THE INVENTION

A review of the dog chew category reveals a large assortment of known chew products for dogs, including dog chews made of a variety of materials and comprising various shapes, sizes and styles. This large assortment centers on the idea that dog chews are an effective method to clean dogs' teeth resulting in better oral hygiene and improved breath for the pet. In addition these items provide a positive time occupier for the pet which prevents them from chewing on other objects like home furnishings and clothing. In certain iterations additives are applied to provide nutritional benefits for the pet. Health and beauty additives can also be applied for enhancing the product and, in turn, its claimed benefits. For example, Vitamin E can be added for improved skin and coat benefits.

Dog Chew products typically include chews made from animal skins such as rawhide, synthetic chew toys made from a variety of materials such as plastic or nylon, and products made from vegetable based formulations like starches and wheat. While a large assortment of products exist in the market place today, they all have inherent flaws that can be improved upon, some of which are addresses by the current invention.

The U.S. dog chew category is currently valued at approximately $913 million dollars in retail sales across all channels of trade. Despite the size and importance of the category it has not shown significant growth despite the growth in pet ownership over the past 10 years. This lack of growth can be attributed to the inherent product limitations and consumer concerns within the categories on all current forms of pet chews. Products currently on the market have consumers well aware of the category flaws. National attention has been given to the product recalls on chew products for various safety concerns, such as chocking and bowel obstruction, as well as salmonella contamination in chews that contain meat. Such attention has elevated pet owner concerns surrounding the digestibility and manufacturing of chews on the market. Safety concerns coupled with the lack of nutritional benefits in common chews emphasizes the clear need for innovation within the category.

Ingredients—Each of the existing chew types have inherent flaws with the base material they are made from, namely rawhide, vegetable/plant material, and/or synthetic material such as nylon. Rawhide is essentially flavorless and provides little to no nutritional value to the pet. Vegetable-based chews contain ingredients that are known allergens for dogs that pet owners look to avoid. Synthetic chews are 100% indigestible for the dog and present a serious threat for chocking or intestinal blockage. A chew made with an internal dairy layer can mitigate at least some of these shortcomings.

Nutrition—Essential nutrients are those required by the pet that either cannot be synthesized by the body or cannot be synthesized in adequate amounts for good health. The biological value of a protein is a measure of that protein's ability to supply amino acids, particularly the 10 essential amino acids, and to supply these amino acids in the proper proportions. In general, animal proteins (meat, dairy, poultry and fish) have higher biological values than vegetable proteins (such as soybean meal or corn gluten meal). Therefore a chew comprising a layer of digestible animal protein (such as dairy) would be more biologically valuable for the pet than vegetable based chews. Rawhide chews provide little to no nutritional value for the pet so they are often sprayed with vitamin additives to provide some nutritional value. A Dairy-based layer within a chew will provide useable amino acids in addition to nutrients such as calcium and vitamins like B, D, E and K, all important to a dog's overall health and well being.

Taste—Rawhide is inherently flavorless and vegetable based ingredients are less palatable to dogs than animal based ingredients. Thus, rawhide and vegetable based chews are often produced with flavor additives, and/or left unfinished by the dog. Dairy products have an inherent flavor that is enjoyable to dogs which will entice the pet to first taste the product and then consume it in its entirety. In addition the Canine sense of smell is at least 100 times more accurate than the human sense of smell. For this reason dogs are considered to be olfactory eaters, i.e. they use their nose to decide what to eat or taste. Unlike vegetable, synthetic or rawhide based chews which have little to no natural scent many dairy products like cheese have a strong aroma. This aroma is pleasing to a dog enticing them to first try and then consume a chew product largely eliminating the need for artificial scent enhancers.

Further, the combination of meat and dairy is one that provides superior palatability for the dog. By making a chew material from an easily pliable and moldable dairy-based blend, the material can easily be incorporated as an internal layer in a variety of chews, enhancing the palatability and nutritional profile of the chew.

The below is a discussion of the four categories of dog-chews, relating to the present invention, existing in the market place today:

4. Animal Skin Based Chews (Rawhide and/or Porkhide)

Rawhide and other forms of animal skins are currently the most common chew for dogs. They are the most common form of chew toys for dogs because they are viewed as natural and as such, while not fully digestible, they are more digestible than synthetic chew toys made from a variety of materials like plastic and nylon. However, despite significant growth in dog ownership and subsequent growth in the dog treat and chew categories, (20% +since 2003), rawhide retail purchases have remained relatively flat since 2003.

Rawhide is flavorless and provides almost no nutritional value for the pet. As cited in a study that looked at the affectivity of rawhide in the removal of dental calculus in dogs which was published in the Journal Veterinary Medicine, Vol. 197, No. 2, Jul. 15, 1990, it was determine that the affectivity of rawhide on the removal of dental calculus in dogs is hampered by the acceptability of the product when compared to other consumable options like biscuits. Many dogs in the study never chewed the provided rawhide, while other would simple leave the majority of the bone unconsumed after the initial tasting. The study found that “A strong relationship between acceptability and time for rawhide was evident, whereas biscuit were accepted from the start. Some dogs would never chew or indicate any interest in rawhide; other dogs would chew it readily from the start, but would not consume it; others would consume it completely.”

However, importantly, rawhide can be beneficial, and when a dog chewed rawhide it was shown to be the most effective method for removing dental calculus from dogs when compared to other options.

It is clear that overcoming acceptance issue inherent with rawhide is the key to making the product an effective method to maintain oral hygiene for a dog. When dogs do not finish a rawhide chew because of its inherent lack of flavor it also diminishes the products value as a time occupier.

As such, in order to combat the lack of acceptance, many products are sprayed, coated or basted with natural or artificial flavorings. Examples would be a beef basted rawhide bone or a bone that is coated with an artificial cheese flavoring to enhance palatability. These create numerous issues for the pet owner as these coatings can stain carpets and furniture and often begin to smell if left unconsumed for a period of time. In addition they do not fully incentivize the dog to consume the chew in its entirety as the dog can simple lick the flavored coating off the outside of the bone.

Another method used to combat the acceptance issue inherent in rawhide is the placement of jerky, poultry or meat inside of rawhide products. One such example of this is the dog chews disclosed by U.S. Pat. No. 5,673,653, showing a meat (jerky) layer secured within a traditional rawhide chew. Since the majority of these jerky products are simple dehydrated meats these jerky products introduce a litany of food borne pathogens to the process like salmonella that would otherwise not be present in rawhide. This creates the potential for contamination of the product for both dogs and the pet owner, as well as any other person coming in contact with the product.

Since 2010 the FDA has issued in excess of 100 salmonella based recalls of pet foods and treats. In addition to introducing food borne pathogens adding jerky to rawhide bones creates a significant cost issue for manufacturing. Because the cost of the dehydrated meats added to rawhide is so high in the North and South America as well as Europe the production of these products to date is done exclusively in China or other Asian nations. In October of 2013 FDA released a warning for dog owners letting them know about a large number of illnesses and fatalities linked to Chinese produced jerky products sold for dogs. The jerky cited by the FDA are identical to the meat added to the center of rawhide bones manufactured in China. The FDA stated, “The agency has repeatedly issued alerts to consumers about reports it has received concerning jerky pet treat-related illnesses involving 3,600 dogs and 10 cats in the U.S. since 2007. Approximately 580 of those pets have died.”

In addition to concerns about quality control the addition of chicken, (the most common jerky used inside of rawhide), also creates allergy concerns. Chicken is a common allergen for dogs and as such an ingredient many pet owners need to avoid. As another alternative, manufactures have added meat to the center of the chew in order to get the pet to chew the product.

5. Plant-Based (Vegetable/Soy/Grain/Starch) Chews

Vegetable based chews, that is chews that use vegetable and/or plant materials as a substantial ingredient, such as the dog chew disclosed by U.S. Pat. No. 6,093,427 and U.S. Pat. No. 7,677,203, are the second most commonly purchased form of chew for dogs. These products are often made from a base material such as wheat, wheat glutens, corn, soy protein isolate, pea protein, potato, tapioca and/or corn starch. There are several issues with these forms of chews.

One such issue is intestinal blockage. The inherent nature of starch-based materials has the potential for expansion once in a pet's stomach. In addition, these formulations are also slowly digested further compounding the issue.

In addition to blockage, allergies can be a problem when using vegetable based chews. Wheat, corn and soy (the most common ingredients used to create vegetable based chews) are among the most common food based allergies for dogs. This fact has become so prevalent with consumers that nearly half of all pet foods sold in the U.S. are now formulated to be free of corn, wheat and soy.

While these vegetables contain a large amount of protein, these proteins provide almost none of the essential amino acids needed by a dog (essential amino acids are those that a dog cannot synthesize and must be received through diet) further limiting the benefit of these chews.

Much like rawhide, there are palatability issues with the base ingredients contained in vegetable chews for dogs. As such palatability enhancers and/or secondary proteins sources are often added to the products to entice consumption. One such example of this is the dog chews disclosed by U.S. Pat. No. 7,677,203, disclosing a protein (preferably jerky) layer secured within a plant-based casing.

6. Synthetic Chews

Many dog chews are made from synthetic materials such as plastic, nylon or rubber. These products often provide a long lasting chew for dogs, but they are completely indigestible. This represents a significant health risk for dogs when they break a portion of the chew off and swallow it. Again, palatability concerns arise as synthetic based chews have no natural flavors of interest to a dog.

Additionally, these synthetic chews are made from plastics and nylons and provide zero nutritional value for the pet.

The present invention discloses a pliable, readily moldable, dairy-based chew material placed in the center of an animal hide based pet chew, preferably rawhide or pork hide. A dairy-based center will provides the traditional benefits of a dog chew, while also providing nutritional, palatability and digestibility benefits, in a safe low cost product.

### SUMMARY OF THE INVENTION

The present invention relates to an edible pet chew that has an outer animal hide material and in internal material made primarily of a dairy base. The dairy base can be a single dairy ingredient or a mixture of dairy ingredients (such as whey, casein, cheese, milk, etc. . . . ), and the dairy base comprises a larger percentage, by weight, than any other combination of ingredients within a particular food group (starch, grain, meat, etc. . . . ) found in the internal pet chew material.

A dairy-based chew material is made by combining dairy-based ingredient(s) (milk, cheese, yogurt, casein, whey, etc. . . . ) with various other ingredients to create a hardened or semi-hardened form, wherein the dairy-based ingredients comprise the largest portion of the formula. The blended mixture will allow for various shapes and textures to be formed out of the materials through a variety of methods of manufacturing. After the mixture is formed into the desired shape, it is dehydrated (fully or partially) and/or cooled. In the preferred embodiment, the dairy-based material will formed into thin pliable sheets that can easily be incorporated into an animal hide chew.

The dairy-based material will improve the nutritional value and palatability of animal hide chews without the need of flavor additives, because of the inherent nutritional value and palatability of the dairy-based raw materials. Further, dogs would receive the benefits of calcium, amino acids and other positive nutritional elements contained within the dairy-based material without the need for additional additives to be applied to the chew.

In one embodiment, the dairy-based material is made with a dairy-based ingredient (milk, cheese, yogurt, etc.), preferably of at least 50%, that is or is not combined with various other ingredients to create a hardened or semi-hardened strip or sheet that is still pliable. It should be understood that a minimum of 50% is preferred, but not required, but in all embodiments the dairy base comprises a larger percentage, by weight, than any other combination of ingredients within a particular food group (starch, grain, meat, etc. . . . ) found in the dairy-based material. The dairy-based material is then added to the center of animal skin based chews using various methods of manufacturing and shapes. One possible method is to superimpose a sheet of dairy-based material on top of a sheet of animal hide, and then to roll, twist or tie the sheets into the desired shape, most commonly the traditional rawhide bone shape. When rolled, twisted or tied into a final shape, the sheet of dairy-based material will be substantially enclosed within the animal hide.

In all embodiments, the dairy-based material should be mostly or wholly encased by the outer animal hide to contain the diary based materials assuring the dog consumes the animal skin portion of the product. In preferred embodiments a small portion of the dairy base center will remain visible to the dog, while the majority of the dairy base center is encased in the animal hide. This will allow animal to taste and smell the palatable center which will encourage initial trial of the chew and it's consumption in its entirety.

Since dogs enjoy the smell and flavor of cheese, yogurt and other dairy products encasing a dairy-based material in the outer animal skin of the product will entice dogs to try animal skin based chew initially and then consume the product it in its entirety in order to get to the dairy-based center material.

### BRIEF DESCRIPTION OF THE DRAWINGS

FIG. 1 illustrates a perspective view of the preferred embodiment for a dog chew of the present invention;

FIG. 2 illustrates a perspective view of an alternate embodiment for a dog chew of the present invention.

### DETAILED DESCRIPTION OF AN EMBODIMENT

In all embodiments of the invention, a chew for dogs is made from a combination of animal hide and a dairy-based material. The term “dairy-based material” as used herein refers to material wherein the composition of the dairy base comprises a larger percentage, by weight, than any other combination of ingredients within a particular food group (starch, grain, meat, preservatives etc. . . . ) found in the composition. Other ingredients like starches, preservatives or meats are only added to a level that allows for the diary based material to stay malleable during manufacturing and allows for the adjustment of the hardness of the final product to accommodate different segments of dogs, i.e. small, large, heavy chewers, light chewers.

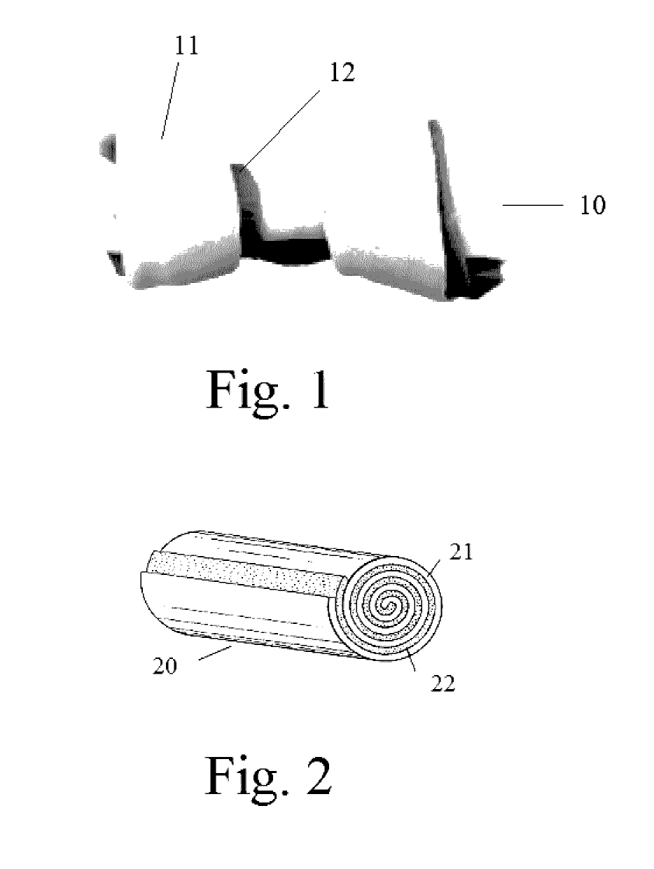

The dairy-based material is an inherently palatable treat for dogs. The aroma and flavor of the dairy-based material entices the dog to chew the product. As shown in FIG. 1, in one exemplary embodiment, a rawhide chew (10) comprises a dairy-based material (12) wrapped within an animal hide (11) tied into a traditional rawhide bone shape. Since the dairy-based material is encompassed within the animal skin, it provides palatability throughout the entirety of the chewing process of the item. Because of the rawhide outside and the time it takes to be consumed by a dog it satiates a dog's natural chewing instinct.

In one embodiment, a dairy base is combined with binding agents and preservatives. These binding agents can be starches like potato, of animal origin like gelatin, or plant based like wheat gluten. In addition preservatives or water stabilizers, like vegetable glycerin, may be added to the formulation for shelf stability. The binding agents added to the dairy are only added to a level that allows the material to reach a pliable texture that can be molded, extruded, or founded. Other binding agents and preservatives may be used in addition to those listed above.

In certain embodiments the dairy-based material (12) is then formed into thin sheets. These thin sheets can be manufactured through extrusion, compression, rolling or dehydrating the material on large trays until it reaches a semi-pliable or non-pliable state. These sheets can then be super imposed inside of the animal skin exterior and then rolled into the shape of a cylinder or cut into shapes. The super imposed animal skin and dairy material may also be cut into strips and then tied into shapes, such a dog bone.

In one embodiment the dairy-based material is made using cheese blocks. The cheese blocks are made from Cheese, (Skim Milk, Enzymes, Salt), with some Pea or Potato Starch and Glycerin added to the block at a level that helps maintain pliability in manufacturing. The cheese block is then melted into a liquid state and combined with additional ingredients like powdered cheese, potato starch, glycerin and potentially others, while ensuring that the dairy is still the largest percentage of the product. This melted product is then laid onto sheets where it is dried into a semi pliable state by removing moisture. Once the desired texture is reached the product is then cut into strips.

In other embodiments the dairy-based material is made by combining a dairy-based ingredient (milk, cheese, yogurt, etc.) with binding agents and preservatives. The mixture is then heated to a temperature so that the material does not burn but is fluid enough that it can be forced through an extruder into strips. The material is then forced through an extruder into thin strips or sheets.

### EXAMPLE 1

In the preferred embodiment, dehydrated cheese powder, that is a blend of specific cheeses made in the U.S.A., and made of 100% cheese (Skim Milk, Enzymes, Salt), is mixed with potato starch, glycerin, sorbitol and potentially other ingredients while ensuring that the dairy is still the first ingredient and largest percentage of the product. This mixture is then heated to a temperature between 165 and 195 degree Fahrenheit using a heater or friction and forced through an extruder head using a spindle. The extruded dairy strips are then super imposed on top of animal hide and tied into shapes like knotted bones, rolls, twists, cylinders etc., so that the dairy material is visible but still encased within the animal hide.

### EXAMPLE 2

A mixture of dairy-based and other ingredients are combined such that the first ingredient of the central material is dairy and the total composition of dairy within the product is greater than any other group of ingredients together. In one embodiment the dairy-based material comprises Whey, Casein (Milk Protein), Glycerin, Gelatin, Cheddar Cheese Powder, Natural Chicken Liver Flavor, Smoke Flavor, Cheese Flavor, Sodium Proponate.

These ingredients are then heated to a liquid state and forced through an extruder head using a spindle. These strips are then cut to various lengths, superimposed on the animal hide and shaped into the final product, as shown in Example 1.

In the preferred embodiment, as shown in FIG. 1, the final product is a knotted rawhide bone (10), with the majority of the dairy-based material (12) enclosed within the rawhide (11). In such embodiments a strip of the dairy-based material is layered onto a strip of rawhide. The multi layered rawhide and dairy-based strip are then rolled into the shape of a bone with knots tied at both ends such that the dairy-based material is encased within the knotted bone and may or may not be visible through center of the knotted bone shape. This would allow for dogs to smell and/or potentially see the dairy-based center, but not remove it without consuming the rawhide outer portion.

In certain versions of the above knotted bone embodiment the dairy-based material preferably stays at or near the edges of the rawhide chew so the dog can see and smell the dairy-based material inside while chewing on the rawhide outside. As an example, in certain iterations the dairy-based material would be visible near the end rawhide sheet but is still located within the rawhide outer layer. This provides the appealing odor to attract the dog to the chew toy before he starts to chew, and provides taste and scent attraction as the dogs begins to chew. Since the dairy material is inside the rawhide the dog must continue to gnaw at the rawhide to disintegrate it to get the dairy-based inside. This means a dog must work his way along the entire chew to get to the dairy-based inside in its entirety.

Further, in some preferred embodiments, the dairy product is positioned such that a small portion of the dairy strip protrudes from the longitudinal seem of the rolled bone shaped rawhide. Once again by exposing a small portion of the dairy-based material you are making the product immediately more attractive to chew from a palatability and odor stand point.

In yet another aspect of the present invention, as shown in FIG. 2, the animal hide (21) and dairy-based material (22) are made into sheets. These sheets are super imposed on top of one another. These two super imposed sheets are then rolled together wrapping the dairy-based entity within the rawhide creating a rawhide outside and dairy-based inside. Unlike the above embodiment the cylindrical shape (20) created would not have knots tied on the ends. In such embodiments, it is preferable that the dairy-based center is visible along the openings on the end of cylindrical shape. In other embodiments a small portion of the dairy-based material would be visible along the seam of the two super imposed materials again allowing for a dog to smell and see the dairy-based material inside to entice them to consume the outer rawhide chew.

In some embodiments, a cylinder (20) is formed using an animal hide and dairy-base made from granular material. These sheets are super imposed on top of one another; they are then rolled so that the dairy-based material is contained within the rawhide. This sheeted roll is then placed into a compression mold where sufficient pressure to harden the product is applied. By applying pressure this product would be harder than sheeted, rolled hide.

In another embodiment the dairy-based material would be added to ground rawhide. In this iteration the combined materials are placed in an open heated mold cavity. The mold is then closed and pressure is applied to force the material into contact with all mold areas. This heat and pressure is maintained until the dairy-based material has been cured. Once this material is cured it is removed from the mold. Additional drying and cooling may or may not be necessary following the molding of the shape to make the material hard enough to be sufficient to withstand dog's chewing. The dairy-based material is contained within the compressed shape enticing the dog to first taste the chew, but also continue to chew it after the initial tasting.

In another embodiment the dairy-based material would be added to ground rawhide. In this iteration the combined materials are heated. The heated material is then forced through an extruder head to form shapes or strips of the material. These shapes or strips are then cut to a desired size or length. Additional drying and cooling may or may not be necessary following the extrusion of these shapes to make the material hard enough to be sufficient to withstand dog's chewing. The dairy-based material is contained within the extruded shape enticing the dog to first taste the chew, but also continue to chew it after the initial tasting.

In certain embodiments either bits of rawhide or sheets of rawhide are formed into a tube shape with a hollow hole in the center. This hole can then be filled with the secondary dairy-based material again exposing it to the dog, but not allowing them to consume it without working through the animal skin on the outside of the chew.

In certain embodiments rawhide can be cut into various anthropomorphic shapes. The dairy-based inside can then sandwiched between two of these rawhide shapes. In this iteration the dairy-based material would be visible along the seam around the circumference of the shape.

While certain embodiments are disclosed within the outline above certain modifications to the product outlines are possible. For example, it is possible make an animal based chew in configurations other than those outlined above, including variances in shape, ingredients or manufacturing technique. As such the described invention is not limited to solely to the embodiments as described above.

In all embodiments, a dairy-based material is enclosed within an outer casing that is predominantly made of animal hide, such that the majority of the dairy-based material is concealed within the outer casing.

What is claimed is:

17. A dog chew comprising an outer animal hide casing an internal dairy-based material, wherein the majority of said internal dairy-based material is concealed within said animal hide outer casing; said outer casing being made of at least 50% animal hide; and said internal material comprising a mixture of one or more dairy ingredients that may or may not be combined with other ingredients, and said mixture of one or more dairy ingredients comprises the largest portion, by weight, of the internal dairy-based material.

18. The dog chew of claim 1, wherein said outer animal hide casing and said internal dairy-based material each comprises a thin sheet: and said sheets are rolled together into a cylinder.

19. The dog chew of claim 2, wherein said a portion of the internal dairy-based material is visible on the exterior of the dog chew.

20. The dog chew of claim 1, wherein said outer animal hide casing and said internal dairy-based material each comprises a thin strip; and said strips are tied into a rawhide bone shape.

21. The dog chew of claim 4, wherein said a portion of the internal dairy-based material is visible on the exterior of the dog chew.

22. The dog chew of claim 1, wherein the outer animal hide casing comprises a shaped piece of animal hide, and said shaped piece of animal hide contains a cavity, and the internal dairy-based material is encapsulated within the cavity of said shaped piece of animal hide.

23. The dog chew of claim 6, wherein said a portion of the internal dairy-based material is visible on the exterior of the dog chew.

24. The dog chew of claim 1, wherein the outer animal hide casing comprises a plurality of shaped pieces of animal hide, and the internal dairy-based material is layered such that the dairy-based material is sandwiched between two or more of said shaped pieces of animal hide.

25. A method for manufacturing a dog chew comprising:
Forming a thin sheet of dairy-based material by heating a mixture one or more dairy ingredients that may or may not be combined with other ingredients at a temperature sufficient to form a liquid mixture, wherein said mixture of one or more dairy ingredients comprises the largest portion, by weight, of the dairy-based material;
pouring the liquid mixture into thin sheets; allowing the thin sheets to cool and dry into a semi-pliable state such that each thin sheet of dairy-based material can be shaped into a final product;
forming a thin sheet of animal hide by cutting pieces of animal hide into a thin sheets;
superimposing said sheet of dairy-based material on said sheet of animal hide; and
rolling said sheets into a cylinder, wherein the majority of the sheet of dairy-based material is enclosed within the sheet of animal hide.

26. The method for manufacturing a dog chew of claim 9 wherein said sheets of animal hide are formed by compressing granular pieces of animal hide together to form a singular sheet.

27. A method for manufacturing a dog chew comprising:
Forming a thin sheet of dairy-based material by heating a mixture of one or more dairy ingredients that may or may not be combined with other ingredients at a temperature sufficient to form a liquid mixture, wherein said mixture of one or more dairy ingredients comprises the largest portion, by weight, of the dairy-based material;
forcing said liquid mixture through an extruder head using a spindle in order to form an extruded sheet of dairy-based material;
forming a thin sheet of animal hide by cutting pieces of animal hide into a thin sheets;
superimposing said sheet of dairy-based material on said sheet of animal hide; and
rolling said sheets into a cylinder, wherein the majority of the sheet of dairy-based material is enclosed within the sheet of animal hide.

28. A method for manufacturing a dog chew comprising:
Forming a thin sheet of dairy-based material by heating a mixture of one or more dairy ingredients that may or may not be combined with other ingredients at a temperature sufficient to form a liquid mixture, wherein said mixture of one or more dairy ingredients comprises the largest portion, by weight, of the dairy-based material;
pouring the liquid mixture into thin strips; allowing the thin strips to cool and dry into a semi-pliable state such that each thin strip of dairy-based material can be shaped into a final product;
Forming a thin strip of animal hide by cutting pieces of animal hide into thin strips;
superimposing said strips of dairy-based material on said sheet or strip of animal hide; and
rolling said strips into a bone shape, wherein the majority of the strip of dairy-based material is enclosed within the strip of animal hide.

29. A method for manufacturing a dog chew comprising:
Forming a thin strip of dairy-based material by heating a mixture of one or more dairy ingredients that may or may not be combined with other ingredients at a temperature sufficient to form a liquid mixture, wherein said mixture of one or more dairy ingredients comprises the largest portion, by weight, of the dairy-based material;
forcing said liquid mixture through an extruder head using a spindle in order to form an extruded strip of dairy-based material;
forming a thin strip of animal hide by cutting pieces of animal hide into thin strips;
superimposing said strips of dairy-based material on said sheet or strip of animal hide; and
rolling said strips into a bone shape, wherein the majority of the strip of dairy-based material is enclosed within the strip of animal hide.

30. A method for manufacturing a dog chew comprising:
Forming a thin strip of dairy-based material by heating a mixture of one or more dairy ingredients that may or may not be combined with other ingredients at a temperature sufficient to form a liquid mixture, wherein said mixture of one or more dairy ingredients comprises the largest portion, by weight, of the dairy-based material; forcing said liquid mixture through an extruder head using a spindle in order to form an extruded sheet of dairy-based material; cutting said sheet of dairy-based material into thin strips
forming thin strips of animal hide by cutting pieces of animal hide into thin strips;
superimposing one of said strips of dairy-based material on one of said sheet or strip of animal hide; and
rolling said superimposed strips into a bone shape, wherein the majority of the strip of dairy-based material is enclosed within the strip of animal hide.

31. A method for manufacturing a dog chew comprising mixing granular rawhide and granular dairy based material;
placing the combined mixture of materials in an open and heated mold cavity;
closing the mold and applying and maintaining pressure to the combined mixture until the dairy-based material has been cured, such that the mixture of granular materials are secured together into a single dog chew and the majority of said granular dairy pieces are concealed within the dog chew; removing the dog chew from the mold.

32. A method for manufacturing a dog chew comprising mixing granular rawhide and granular dairy based material;
heating the combined mixture of materials to a temperature sufficient to form a liquid mixture;
forcing the heated mixture through an extruder head to form shapes or strips of the mixture, such that the mixture of granular materials are secured together into a single shaped dog chew and the majority of said granular dairy based material are is concealed within the shaped dog chew;
cutting said shapes to a desired size or length.
